(19) United States
(12) Patent Application Publication
(10) Pub. No.: US 2007/0086185 A1
(43) Pub. Date: Apr. 19, 2007

(54) Electroluminescent device having a plurality of light emitting diodes

(76) Inventor: Yi Feng Hwang, Perak (MY)

Correspondence Address: AVAGO TECHNOLOGIES, LTD., P.O. BOX 1920, DENVER, CO, 80201-1920, US

(21) Appl. No.: 11/252,655

(22) Filed: Oct. 18, 2005

(51) Int. Cl. F21V 9/00

(52) U.S. Cl. 362/231

(57) ABSTRACT

An improved electroluminescent device (“IED”) including a plurality of LEDs and a plurality of terminals, where one of the terminals is a common terminal providing either an incoming or outgoing current connection to all of the LEDs of the device, and at least one of the LEDs is attached to the common terminal, which is utilized as a heat dissipation path for the attached LED. The LED attached to the common terminal is in electrical connection with at least one other LED of the plurality of LEDs to complete the electrical connection for the attached LED.

### BACKGROUND OF THE INVENTION

Light emitting diodes (“LEDs”) are, in general, miniature semiconductor devices that employ a form of electroluminescence resulting from the electronic excitation of a semiconductor material to produce visible light. Initially, the use of these devices was limited mainly to display functions on electronic appliances and the colors emitted were red and green. As the technology has improved, LEDs have found a wide range of new uses and applications.

One of these applications is backlighting for flat-panel displays, nearly all of which use liquid crystal display (“LCD”) technology. In addition to LED backlighting, other common methods of backlighting for LCD displays are cold cathode fluorescent lamp (“CCFL”) backlighting, electroluminescence panel (“ELP”) backlighting, woven fiber backlighting, and incandescent backlighting. The advantages of LED backlighting are its low cost, long life, immunity to vibration, low operational voltage, and precise control over its intensity. The main drawback is that LED backlighting requires more power than the other methods, and this may be a major drawback if the LCD display size is large enough.

LED backlights come in a variety of colors, with yellow-green being the most common. With the emergence of full color LCD displays, there is a greater need for white LED backlighting, and now white LEDs are becoming cost effective and therefore more widespread in use. Generally, white light can be made in an LED in three different ways: by mixing reds, greens, and blues; by using an ultraviolet LED to stimulate a white phosphor; or by using a blue-emitting diode that excites a yellow-emitting phosphor embedded in an epoxy dome, where the combination of blue and yellow makes a white-emitting LED. Also, by combining a white phosphor LED with multiple amber LEDs, a range of different whites can be created.

The combination of Red, Green, and Blue LEDs in one discrete package, or in a lamp assembly housing a cluster of diodes, is the preferred method in applications that require a full spectrum of colors from a single point source. In the manufacturing process, the LEDs may be mounted on a substrate that may include a integrated circuit (“IC” or “chip”), a printed circuit board (“PCB”) and may have terminals or leads attached. It is appreciated by those skilled in the art that each of the LEDs or substrate may be described as a “die” which refers to an individual monolithic device and therefore may be interchangeably used with the terms “IC” or “chip.” The LEDs may be mounted using conductive paste, because the substrate may form one of the two diode connections. The LEDs may also be wire bonded to an interconnection pattern. Depending on how the Red, Green, and Blue LEDs are internally connected in the package, the RGB LEDs are referred to as a Common Anode or Common Cathode type, with the former being predominant. There are also versions where all LED connections have been wire bonded out.

FIG. 1 shows a schematic illustrating a conventional common anode type of RGB electroluminescent device 100. Terminals (which may also be referred to as mount leads in other types of devices) 102, 104, and 106 are each electrically connected to a Red, Green, and Blue LED (not shown), respectively, mounted on a pad on a substrate within RGB electroluminescent device 100. This electrical connection is where the current flows out of the electroluminescent device and may be made by bonding wires to the n electrode of the respective LEDs. The Common Anode terminal 108 (where the current flows into the device) may be connected to the p electrodes of the Red, Green, and Blue LEDs by bonding wires also. By using a common anode, the number of terminals (or leads) on the electroluminescent device may be reduced.

The entire package may be encapsulated within a shell 120, which may be glass or plastic, and an encapsulant material 122. The encapsulant material 122 may be an epoxy or a polymer material, and both the shell 120 and the encapsulant material 122 are preferably transparent or substantially optically transmissive with respect to the wavelength of the light produced by the LEDs.

To obtain white color by mixing RGB LEDs, the intensity of the individual Red, Green, and Blue LEDs should be maintained in a ratio of approximately 4:12:1. Based on this ratio, the intensity of a single Green LED should be approximately three times that of the Red LED and approximately twelve times that of the Blue LED. With current LED die technology, the intensity of pure Green LEDs may be greater than that of the Red and Blue LEDS; however, based on the 4:12:1 ratio, a single Green LED is insufficient to fully maximize the usage of the intensity of the Red and Blue LEDs. As an example, a typical bright Red LED may have an intensity of 150 millecandela (“mcd”) at 20 mA, while a Green LED may have an intensity of 300 mcd at 20 mA, and a Blue high intensity LED an intensity of 60 mcd at 20 mA. One method of overcoming this problem is to use two Green LEDs together with one Red and one Blue LED.

With the additional Green LED, another problem arises where the total power of the package increases in comparison to a conventional RGB package. In a conventional device, each terminal, excluding the common anode or common cathode terminal, may be used as a heat dissipation path. However, when the number of LEDs exceeds the number of terminals available for heat dissipation paths, heat dissipation for the entire LED device may be adversely affected. Therefore, the heat generated by the additional Green LED needs to be efficiently dissipated to ensure adequate maximum drive current without compromising the reliability of the package. For example, the semiconductor junction temperature, which increases as more current is applied, may be high enough to cause the encapsulant material in the electroluminescent device to expand and contract, thus causing displacement of the wire bonding and resulting in premature wear-out and even failure of the electroluminescent device.

In general, there are two configurations of wire bonding utilized in multiple die configurations to connect the anodes and the cathodes of the multiple die attached to a substrate. FIG. 2A shows a cross-sectional side view of a single LED die structure 200 with a bond pad 202 attached to its upper surface. The bond pad 202 may serve as the anode connection for the single LED die structure 200, which connection is made by attaching a wire bond to the bond pad 202. The cathode connection may be located on the bottom surface of the LED die structure 200, in the form of backside metallization 204, which may be implemented by attaching a conducting material to the bottom of LED die structure 200. The backside metallization 204 may utilize gold, aluminum, or any other conductor, and may be configured as diagonal lines, pads, or other shapes positioned on the bottom surface of the single LED die structure 200. FIG. 2B shows the schematic symbol for the LED die structure shown in FIG. 2A having this type of configuration for wire bonding.

The second configuration is shown in FIG. 3A, which shows a cross-sectional side view of a single LED die structure 300 with two bond pads 302 and 304 attached to its upper surface. The bond pad 302 may serve as the anode connection for the single LED die structure 300, which connection is made by attaching a wire bond to the bond pad 302, and the bond pad 304 may serve as the cathode connection for the single LED die structure 300. FIG. 3B shows the schematic symbol for the single LED die structure shown in FIG. 3A having this second type of configuration for wire bonding.

There are two basic configurations of an RGGB electroluminescent device, i.e., an electroluminescent device with one Red LED, two Green LEDs, and one Blue LED, currently in use. In the first configuration, the second Green pad is isolated from the first Green pad. FIG. 4 shows a cross-sectional top view illustrating a surface mount chip, RGGB electroluminescent device 400, that uses a common-anode type configuration. Terminals 402, 404, and 406 are physically and electrically connected to Red LED 422, first Green LED 426, and Blue LED 424, respectively, to complete the cathode connection. This connection may be by wire bonding (not shown). Red LED 422, first Green LED 426, and Blue LED 424 may each be mounted on a separate pad 412, 416, and 414, respectively. The pads 412, 416, and 414 may be mounted on a substrate 410, which mounting may be done using a conductive paste (not shown), in which case the substrate 410 may be used as one of the LED die diode connections. Although pads 412, 416, and 414 are shown and numbered as separate elements, it is appreciated by those skilled in the art that pads 412, 416, and 414 may be a part of terminals 402, 404, and 406, respectively, that may be integrated into substrate 410. Common anode terminal 408 is electrically connected to the p-electrodes of Red LED 422, Green LED 426, and Blue LED 424, and provides the incoming current to the RGGB LED 400.

In another method of construction, a lead frame may be used instead of a substrate, in which case there are mount leads and an inner lead instead of terminals and a common anode terminal, respectively. In this method, each LED may be placed in a reflector cup supported by a mount lead, and the reflector cup is filled with an epoxy resin or ultraviolet curable composition. The frame is normally etched silver plated steel, which provides better heat conduction than the terminals of an electroluminescent device constructed with the PCB type substrate method. Nonetheless, the same problems with heat dissipation may also exist in an electroluminescent device constructed using this method.

The second Green LED 428 may be positioned in the RGGB electroluminescent device 400 on a pad 418 that is separate from that used by first Green LED 426, pad 416. The cathode 432 of second Green LED 428 and the anode 434 of first Green LED 426 may be connected electrically to each other by wire bonding 430. Thus, terminals 402, 404, and 406 function as heat paths for one die each, Red LED 422, first Green LED 426, and Blue LED 424, respectively. However, the heat generated by second Green LED 428 may only be conducted out of RGGB electroluminescent device 400 through the PCB substrate 410 under pad 418 and the epoxy encapsulant (not shown). Because both of these materials have poor thermal conductivity, second Green LED 428 will experience higher junction temperatures compared to the other die in the RGGB electroluminescent device 400 when driven at the same conditions, which may result in premature luminance degradation and a shorter life expectancy for the RGGB electroluminescent device 400.

FIG. 5 shows a cross-sectional top view of another configuration of an RGGB surface mount chip electroluminescent device 500, where second Green LED 528 and first Green LED 526 share the same pad 516. As in the configuration shown in FIG. 4, the cathode 532 of second Green LED 528 and the anode 534 of first Green LED 526 are connected electrically to each other by wire bonding 530. In this implementation, second Green LED 528 is now able to dissipate heat through terminal 504, which may lower the junction temperature of both second Green LED 528 and first Green LED 526. However, because both second Green LED 528 and first Green LED 526 are dissipating heat through the same heat dissipation path, this may significantly decrease the efficiency of terminal 504 as a heat dissipation path.

Therefore, there is a need to efficiently dissipate the heat generated in an electroluminescent device that includes more LEDs than terminals or leads available for heat dissipation, excluding a terminal or lead to be used as a common anode or common cathode. Additionally, this problem of heat dissipation should preferably be solved without increasing the package size or adding additional terminals or leads.

### SUMMARY

An improved electroluminescent device (“IED”) including a plurality of LEDs and a plurality of terminals, where one of the terminals is a common anode or a common cathode terminal in which one of the LEDs is physically connected to the common anode or the common cathode terminal, is disclosed. The LED physically connected to the common anode or common cathode terminal, as the case may be, is electrically connected to another LED in the IED, and heat from the LED physically connected to the common terminal is dissipated through the common terminal.

In an example implementation, the IED may be an RGGB IED that may include a Red LED, two Green LEDs, and a Blue LED configured to emit a white light, in a Common Anode configuration, i.e., with three cathode terminals and one common anode terminal. The second Green LED is both attached and electrically connected to the common anode terminal and is also electrically connected to the first Green LED. Because of its attachment to the common anode terminal, the second Green LED is able to use the common anode terminal as its heat dissipation path. The RGGB IED may also be configured as a Common Cathode device, i.e., with three anode terminals and one common cathode terminal.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon; illustrating the principles of the invention. In the figures, like reference numerals designate corresponding parts throughout the different views.

FIG. 1 shows a schematic illustrating a conventional Common Anode type of RGB LED 100.

FIG. 2A shows a cross-sectional side view of a single LED die structure with electrical connections on both the top and the bottom surfaces, and FIG. 2B shows a schematic symbol for such an LED die structure.

FIG. 3A shows a cross-sectional side view of a single LED die structure with both of its electrical connections on the top surface, and FIG. 3B shows a schematic symbol for such an LED die structure.

FIG. 4 shows a cross-sectional top view illustrating a RGGB surface mount chip electroluminescent device.

FIG. 5 shows a cross-sectional top view illustrating another implementation of a RGGB surface mount chip electroluminescent device.

FIG. 6 shows a cross-sectional top view illustrating an implementation of a RGGB surface mount chip Common Anode type IED that includes an LED physically connected to the common anode terminal of the IED in accordance with the invention.

FIG. 7 shows a cross-sectional top view illustrating another implementation of a RGGB surface mount chip Common Anode type IED that includes an LED physically connected to the common anode terminal of the IED in accordance with the invention.

FIG. 8 shows a schematic symbol diagram for the implementations shown in FIGS. 6 and 7.

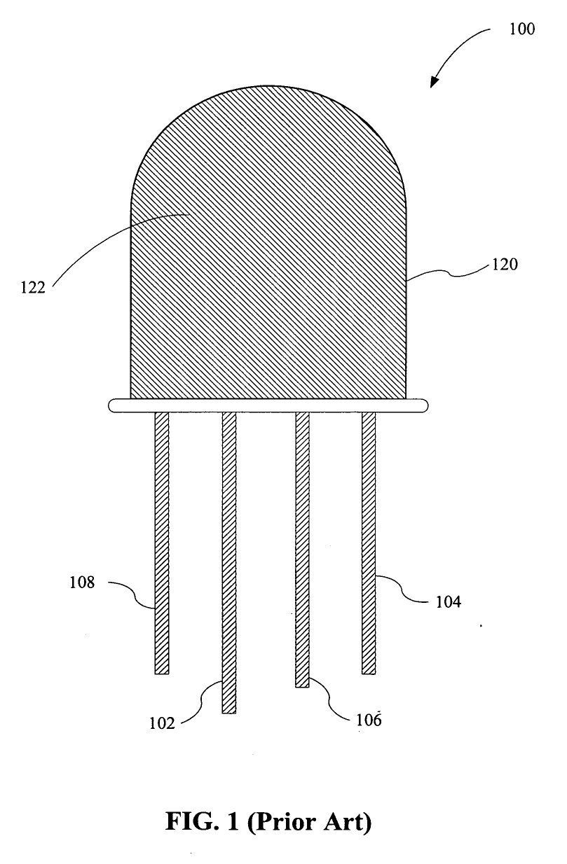

### DETAILED DESCRIPTION

In the following description of the preferred embodiment, reference is made to the accompanying drawings that form a part hereof, and which show, by way of illustration, a specific embodiment in which the invention may be practiced. Other embodiments may be utilized and structural changes may be made without departing from the scope of the present invention.

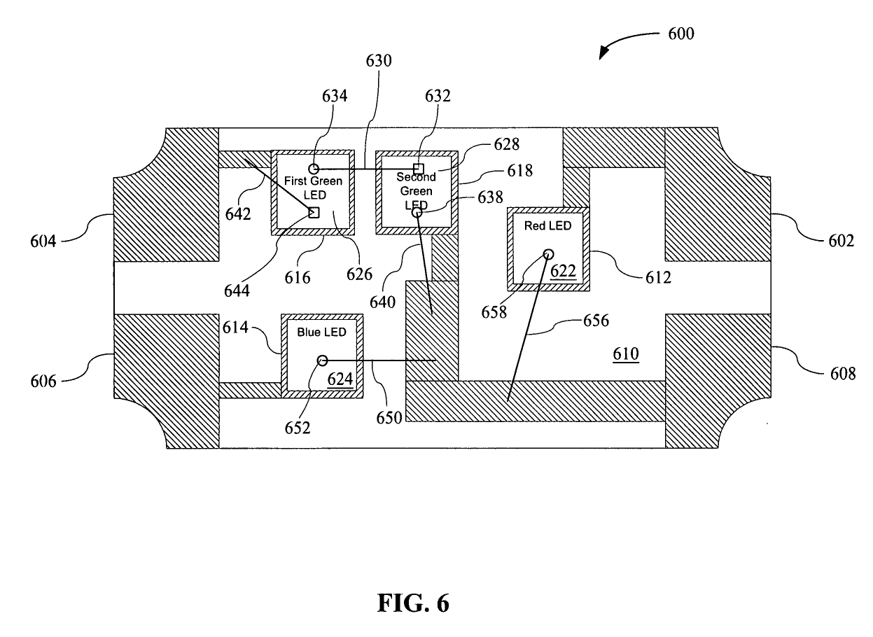

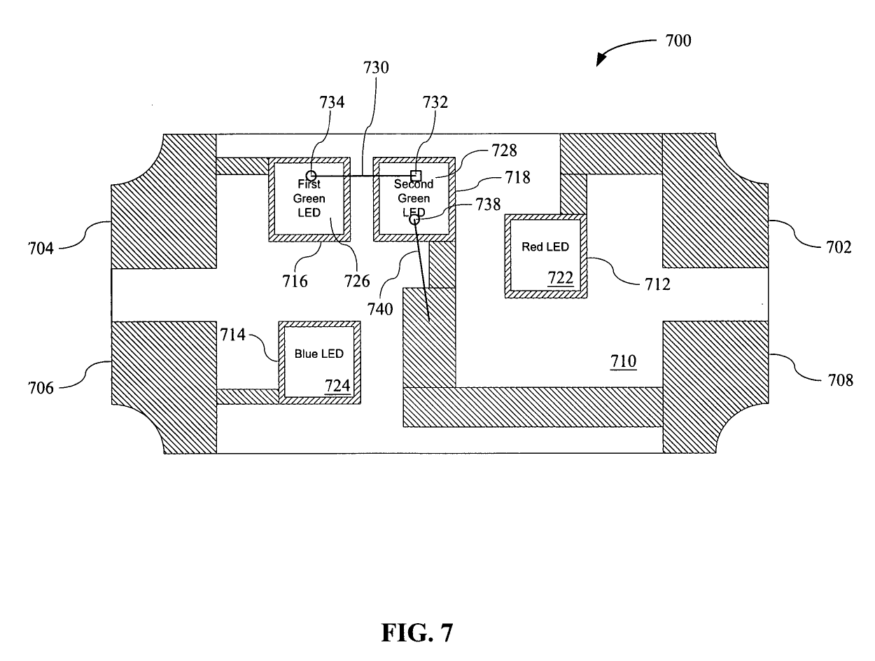

In general, the invention discloses a system and a method of configuring an improved electroluminescent device (“IED”) having multiple LEDs, such as an RGGB IED so that at least one of the LEDs in the IED is attached to the common anode terminal in a common anode type of IED, or to the common cathode terminal in a common cathode type of IED, so as to create a heat dissipation path that utilizes the common terminal. In general, the term “attached” refers to a physical connection or attachment between two or more elements such that all of the elements together form a single heat dissipation path. For purposes of illustration, FIGS. 6 and 7 show a RGGB common anode IED that is, an IED having one Red LED, two Green LEDs, and one Blue LED, primarily because this combination of LEDs is commonly used to produce white light, implemented in a device having four terminals (or leads). However, the scope of the invention is intended to cover any IED having multiple LEDs of varying colors where at least one of the LEDs may be attached to the common terminal of the IED, e.g., the common anode terminal in the common anode type of IED or the common cathode terminal in the common cathode type of IED.

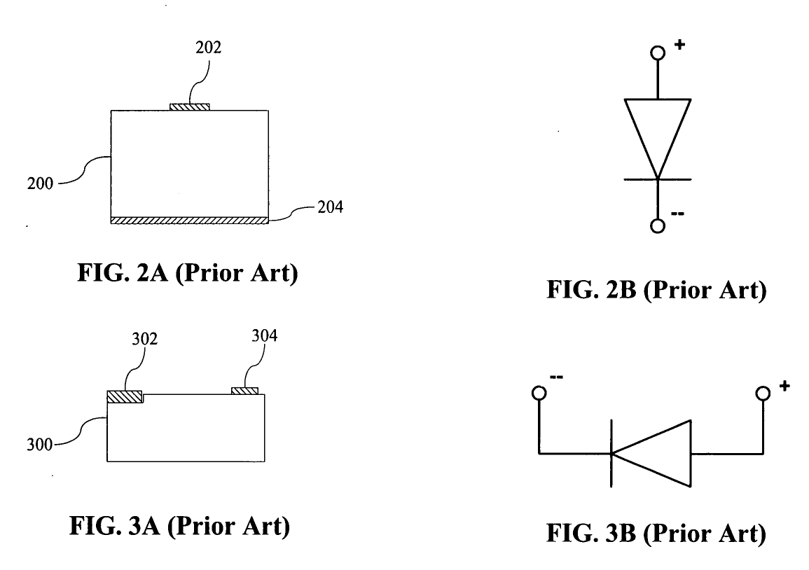

FIG. 6 shows a cross-sectional ton view illustrating an implementation of an RGGB surface mount chip IED device 600 of the Common Anode type. First Green LED 626 is shown having bond pads 634 and 644, and second Green LED 628 is shown having bond pads 638 and 632, for the anode and the cathode connections, respectively, to the LED die structure, on the top surface. As for Red LED 622 and Blue LED 624, these LEDs are shown having single bond pads 658 and 652, respectively, on the top surface. Thus, the cathode connections for Red LED 622 and Blue LED 624 may be made using the backside metallization 204 as shown in FIG. 2A. However, it is appreciated by those skilled in the art that Red LED 622 and Blue LED 624 may also be connected utilizing the configuration as shown in FIG. 3A, i.e., having two bond pads on the top surface.

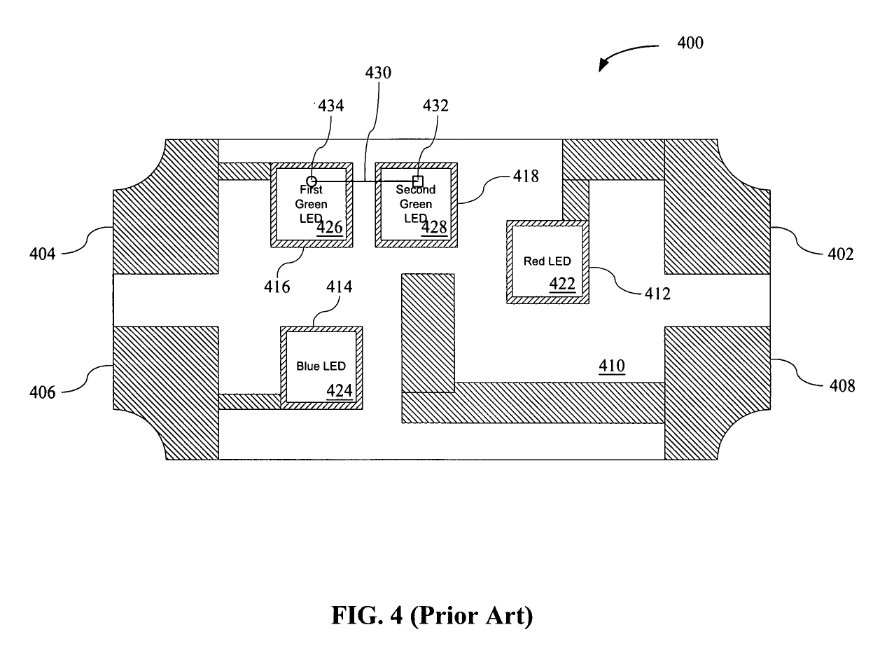

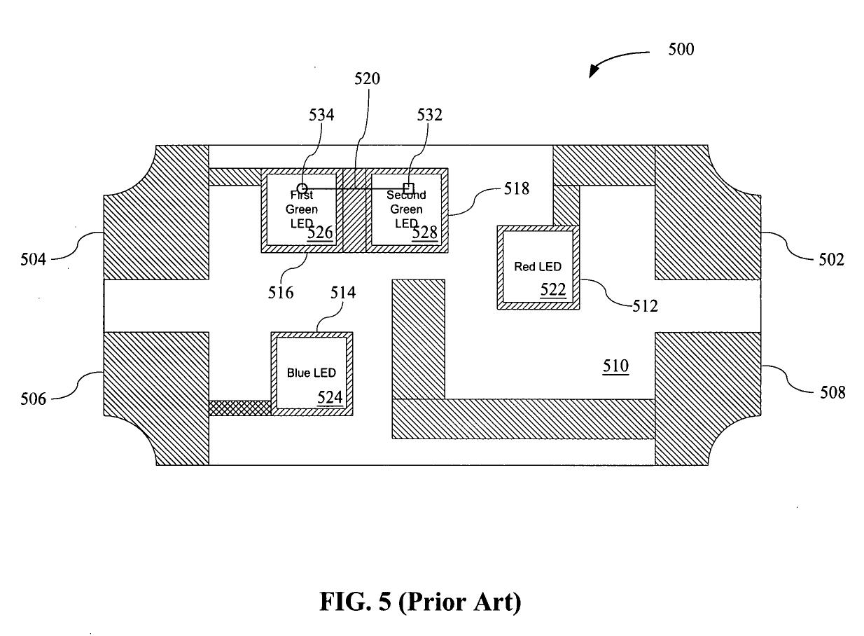

As in FIGS. 4 and 5, cathode terminals 602, 604, and 606 are electrically connected to Red LED 622, first Green LED 626, and Blue LED 624, respectively. This connection may be by wire bonding (not shown for Red LED 622 and Blue LED 624) from the cathode terminal to the n-electrode/cathode of the respective LED die. Red LED 622, first Green LED 626, and Blue LED 624 may be each mounted on a separate pad 612, 616, and 614, respectively. The pads 612, 616, and 614 may be mounted on a substrate 610, which mounting may be done by laminating the pads onto the substrate 610 during the PCB fabrication process. Although pads 612, 616, and 614 are shown and numbered as separate elements, it is appreciated by those skilled in the art that pads 612, 616, and 614 may be a part of terminals 602, 604, and 606, respectively, that may be integrated into substrate 410.

Common anode terminal 608, which provides the incoming current to the RGGB IED 600, may be electrically connected to the p-electrodes/anodes of Red LED 622 and Blue LED 624 by bonding wires 656 and 650, respectively. Second Green LED 628 may be mounted on a pad 618 that is attached to common anode terminal 608, and second Green LED 628 and first Green LED 626 may be connected electrically to each other by wire bonding 630 connecting the p-electrode/anode 634 of first Green LED 626 to the n-electrode/cathode 632 of second Green LED 628. As in the case of pads 612, 616, and 614, pad 618 may be a part of terminal 608 that may be integrated into substrate 610. Common anode terminal 608 may also be connected to the p-electrode/anode 638 of second Green LED 628 by bonding wire 640. However, it is appreciated by those skilled in the art that the p-electrode/anode 638 of second Green 628 may also be connected to common anode terminal 608 utilizing the backside metallization 204 shown in FIG. 2A.

Therefore, although second Green LED 628 and first Green LED 626 are connected electrically to each other by wire bonding 630, their pads 618 and 616, respectively, are physically separate. Thus, common anode terminal 608 acts as the heat dissipation path for second Green LED 628. This is possible because unlike the other dice, Red LED 622, first Green LED 626, and Blue LED 624, whose outgoing electrical connections are via terminals 602, 604, and 606, respectively, the outgoing electrical connection for second Green LED 628 is via wire bonding 630 to first Green LED 626 and then through terminal 604. Therefore pad 618 may be attached to common anode terminal 608 while also being electrically connected to common anode terminal 608 for the incoming current connection.

This allows each of the four terminals to dissipate heat for a single LED, thus maximizing the efficiency of each heat dissipation path. More efficient heat dissipation will allow an increase in current through the dice, which will increase the intensity of the light emitted by the IED 600.

FIG. 7 shows a cross-sectional top view illustrating another implementation of an RGGB surface mount chip IED 700 of the Common Anode type. Second Green LED 728 is shown having bond pads 738 and 732 for the anode and the cathode connections, respectively, to the LED die structure on the top surface, while first Green LED 726 is shown having a single bond pad 734 for the anode connection on its top surface. As for Red LED 722 and Blue LED 724, bond pads are not shown and it is appreciated by those skilled in the art that both Red LED 722 and Blue LED 724 may be constructed utilizing either of the configurations shown in FIGS. 2A and 3A.

As in FIGS. 4 and 5, cathode terminals 702, 704, and 706 are electrically connected to Red LED 722, first Green LED 726, and Blue LED 724, respectively. This connection may be by wire bonding (not shown) from the cathode terminal to the n-electrode/cathode of the respective LED die utilizing the configurations shown in either FIG. 2A or FIG. 3A. Red LED 722, first Green LED 726, and Blue LED 724 are each mounted on a separate pad 712, 716, and 714, respectively. The pads 712, 716, and 714 may be mounted on a substrate 710, which mounting may be done by laminating the pads onto the substrate 710 during the PCB fabrication process. Again, although pads 712, 716, and 714 are shown and numbered as separate elements, it is appreciated by those skilled in the art that pads 712, 716, and 714 may be a part of terminals 702, 704, and 706, respectively, that may be integrated into substrate 710.

Common anode terminal 708, which provides the incoming current to the RGGB IED 700, may be electrically connected to the p-electrodes/anodes of Red LED 722 and Blue LED 724 by bonding wires (not shown). The second Green LED 728 may be mounted on a pad 718 that is attached to common anode terminal 708, and second Green LED 728 and first Green LED 726 may be connected electrically to each other by bonding wire 730 connecting the p-electrode/anode 734 of first Green LED 726 to the n-electrode/cathode 732 of second Green LED 728. As in the case of pads 712, 716, and 714, pad 718 may be a part of terminal 708 that may be integrated into substrate 710. Common anode terminal 708 may also be connected to the p-electrode/anode 738 of second Green LED 728 by bonding wire 740. However, it is appreciated by those skilled in the art that the p-electrode/anode 738 of second Green 728 may also be connected to common anode terminal 708 utilizing the backside metallization 204 shown in FIG. 2A.

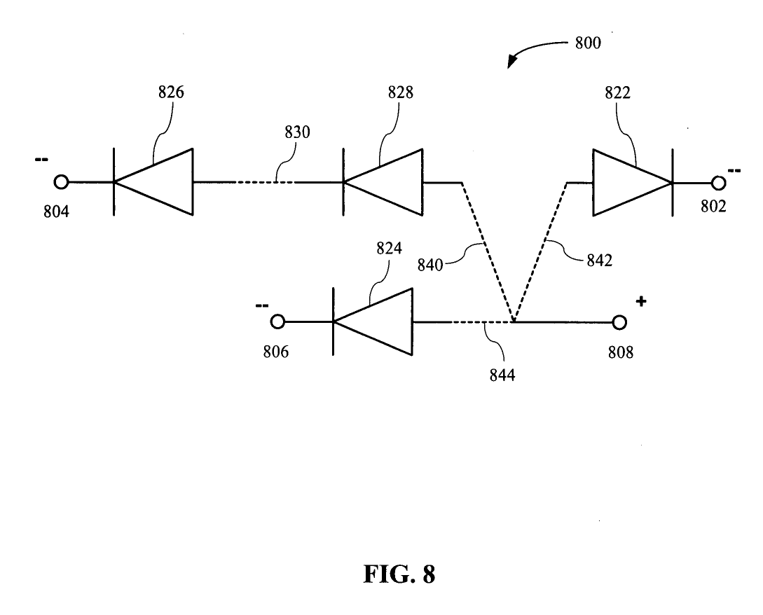

FIG. 8 shows a schematic symbol diagram for the implementations shown in FIGS. 6 and 7, where nodes 802, 804, 806, and 808 correspond to terminals 602, 604, 606, and 608, respectively, of FIG. 6, and terminals 702, 704, 706, and 708, respectively, of FIG. 7, and where LEDs 826, 828, 822, and 824 represent the first Green LED 626, the second Green LED 628, the Red LED 622, and the Blue LED 624, respectively, of FIG. 6, and the first Green LED 726, the second Green LED 728, the Red LED 722, and the Blue LED 724, respectively, of FIG. 7. Thus, nodes 802, 804, and 806 represent the cathode connections of their respective LEDs, and node 808 represents a common anode terminal.

Segment 830 represents the bonding wire 630, FIG. 6, connecting the negative connection 632 of second Green LED 628, FIG. 6, with the positive connection 634 of first Green LED 626, FIG. 6, and the bonding wire 730, FIG. 7, connecting the negative connection 732 of second Green LED 728, FIG. 7, with the positive connection 734 of the Green LED 726, FIG. 7. Segments 842 and 844 represent the bonding wires 656 and 650 connecting the common anode terminal 608, FIG. 6, with the positive connection 658 of Red LED 622, FIG. 6, and the positive connection 652 of Blue LED 624, FIG. 6, respectively, and the corresponding connections (not shown) of FIG. 7. Segment 840 represents the bonding wire 640 connecting the common anode terminal 608, FIG. 6, with the positive connection 638 of second Green LED 628, FIG. 6, and the bonding wire 740 connecting the common anode terminal 708, FIG. 7, with the positive connection 738 of second Green LED 728, FIG. 7.

While the foregoing description refers to an RGGB IED with a PCB substrate, the subject matter of this disclosure is not limited to such a device but also includes, in general, any IED where the number of LEDs in the IED exceeds the number of terminals less one for the common anode or cathode terminal. Additionally, IEDs constructed with a different method of construction, such as the lead frame method, may be implemented in the manner described above.

Moreover, it will be understood that the foregoing description of numerous implementations has been presented for purposes of illustration and description. It is not exhaustive and does not limit the claimed inventions to the precise forms disclosed. Modifications and variations are possible in light of the above description or may be acquired from practicing the invention. The claims and their equivalents define the scope of the invention.

What is claimed:

1. An improved electroluminescent device (“IED”) capable of emitting visible light, the IED comprising:
a plurality of terminals, wherein one of the terminals is a common terminal for a positive or a negative electrical connection to the IED;
a plurality of light emitting diodes (“LEDs”), each with a positive and a negative electrical connection, in number equal to or greater than the number of the plurality of terminals;
wherein the common terminal is attached to at least one of the plurality of LEDs,
wherein the LED attached to the common terminal is electrically connected to at least one other LED of the plurality of LEDs, and
wherein each terminal is electrically connected to the LED to which it is attached.

2. The IED of claim 1, wherein the plurality of LEDs include a Red LED, a first Green LED, a second Green LED, and a Blue LED.

3. The IED of claim 2, wherein the second Green LED is attached to the common terminal.

4. The IED of claim 3, wherein the negative connection of the second Green LED is electrically connected to the positive connection of the first Green LED.

5. The IED of claim 3, wherein the positive connection of the second Green LED is electrically connected to the negative connection of the first Green LED.

6. The IED of claim 1, wherein the common terminal is a common anode terminal.

7. The IED of claim 8, wherein the negative connection of the at least one LED that is connected to the common terminal is electrically connected to the positive connection of at least one other LED.

8. The IED of claim 7, wherein the common terminal is electrically connected to the positive connection of the at least one LED that is attached to the common terminal and to the positive connections of each of the other LEDs with the exception of the at least one LED that is electrically connected to the LED attached to the common terminal.

9. The IED of claim 8, wherein the plurality of LEDs includes a Red LED, a first Green LED, a second Green LED, and a Blue LED, wherein the second Green LED is attached to the common terminal and the negative connection of the second Green LED is electrically connected to the positive connection of the first Green LED.

10. The IED of claim 1, wherein the common terminal is a common cathode terminal.

11. The IED of claim 10, wherein the positive connection of the at least one LED that is attached to the common terminal is electrically connected to the negative connection of at least one other LED.

12. The IED of claim 13, wherein the common terminal is electrically connected to the negative connection of the at least one LED that is attached to the common terminal and to the negative connections of each of the other LEDs with the exception of the LED that is electrically connected to the at least one LED attached to the common terminal.

13. The IED of claim 12, wherein the plurality of LEDs includes a Red LED, a first Green LED, a second Green LED, and a Blue LED, wherein the second Green LED is attached to the common terminal and the positive connection of the second Green LED is electrically connected to the negative connection of the first Green LED.

14. A method for producing an improved electroluminescent device (“IED”) capable of emitting visible light, the method comprising:
attaching a plurality of LEDs, each having a positive and a negative connection, to a substrate having a plurality of terminals, including a common terminal;
attaching the common terminal to at least one LED of the plurality of LEDs;
attaching a terminal of the plurality of terminals to each of the plurality of LEDs, excluding the at least one LED connected to the common terminal;
electrically connecting the negative connection of the LED attaching to the common terminal to the positive connection of one other LED of the plurality of LEDs; and
electrically connecting the common terminal to the plurality of LEDs, excluding the one other LED of the plurality of the LEDs.

15. The method of claim 14, wherein the plurality of LEDs includes a Red LED, a first Green LED, a second Green LED, and a Blue LED.

16. The method of claim 15, wherein attaching the common terminal to at least one LED includes attaching the common terminal to the second Green LED.

17. The method of claim 16, further including electrically connecting the negative connection of the second Green LED and the positive connection of the first Green LED.

18. The method of claim 17, wherein electrically connecting the common terminal to the plurality of LEDs further includes electrically connecting the common terminal to the positive connection of each of the plurality of LEDs excepting the first Green LED.

19. The method of claim 18, wherein the second Green LED has two bond pads positioned on its top surface for making a positive and a negative connection to the second Green LED.

20. A method for producing an improved electroluminescent device (“IED”) capable of emitting visible light, the method comprising:
attaching a plurality of LEDs, each having a positive and a negative connection, to a substrate having a plurality of terminals, including a common cathode terminal;
attaching the common terminal to at least one LED of the plurality of LEDs;
attaching a terminal of the plurality of terminals to each of the plurality of LEDs, excluding the at least one LED attached to the common terminal;
electrically connecting the positive connection of the LED connected to the common terminal to the negative connection of one other LED of the plurality of LEDs; and
electrically connecting the common terminal to the plurality of LEDs, excluding the one other LED of the plurality of the LEDs.
